(19) United States
(12) Patent Application Publication
(10) Pub. No.: US 2010/0185616 A1
(43) Pub. Date: Jul. 22, 2010

(54) SYSTEMS AND METHODS FOR PREDICTIVE RECOMMENDATIONS

(75) Inventor: Daniel R. Baran, Mill Valley, CA (US)

Correspondence Address: NIXON PEABODY, LLP, 401 9TH STREET, NW, SUITE 900, WASHINGTON, DC, 20004-2128, US

(73) Assignee: CBS INTERACTIVE, INC., Wilmington, DE (US)

(21) Appl. No.: 12/353,793

(22) Filed: Jan. 14, 2009

(51) Int. Cl. G06F 7/06; G06F 17/30

(52) U.S. Cl. 707/736; 707/E17.108; 707/758

(57) ABSTRACT

Systems and methods for tagging websites with recent asset information and storing the tagged recent asset information in a database that includes tagged existing asset information, identifying relationships between the recent asset information and the existing asset information, identifying a technical experience for a user by matching user data with the tagged asset information using a technical experience definition and delivering the technical experience to the user are described.

### BACKGROUND

1. Field

The subject invention relates to systems and methods for predictive recommendations.

2. Related Art

Internet users often use the Internet to research online content related to their personal products and to purchase products. During the process of purchasing products, online merchants have in the past provided suggestions for additional products that the user may want to purchase. Merchants also advertise products that users can purchase on other websites.

These recommendation experiences have typically provided only product suggestions that are identified based on a one-dimensional relationship between the product and the user (i.e., a simple product to user map) using collaborative filters. Collaborative filters essentially recommend products that similarly situated users bought in the past. For example, Amazon.com recommends products based on past purchases and user behavior. This recommendation model, however, is fundamentally reactive in nature.

Another problem with these collaborative filters is that they fail to account for new products. New products are coming out all the time, many of which would be more appropriate for what a user may want or need than the products identified by the collaborative filters. Sine the collaborative filters use simple asset-to-user maps, the suggestions are not predictive of potential new technology categories that the user is likely to extend into in the future.

### SUMMARY

The following summary of the invention is included in order to provide a basic understanding of some aspects and features of the invention. This summary is not an extensive overview of the invention and as such it is not intended to particularly identify key or critical elements of the invention or to delineate the scope of the invention.

According to an aspect of the invention, a computer system is provided. The computer system may include a user data store configured to store user data; an asset data store configured to store tagged asset data; and a processor coupled with the user data store and the asset data store, the processor configured to crawl websites for recent asset information, generate at least some of the tagged asset data from the recent asset information, identify connections between the recent asset information and existing asset information in the asset data store, match the user data to the tagged asset data in the asset data store using a technical experience definition and the identified connections to identify a technical experience for the user and deliver the technical experience to the user.

The user data may be provided by the user.

The user data may be determined by analyzing user cookies for user asset behavior.

The technical experience may include one or more of a new product alert, editorial content, a review, a forum, a video, a download, an update, detailed product information, a link to a new product alert, a link to editorial content, a link to a review, a link to a forum, a link to a video, a link to a downloads a link to an update, and a link to detailed product information.

The processor may be configured to crawl one or more of forums, blogs, reviews, articles and channel databases for new asset information.

The tagged asset data may be for one or more of a product and a service.

The asset data may include asset properties and asset attributes.

The technical experience definition may include a rule that analyzes and assigns weights to the user data and tagged asset data based in part on the connections between the recent asset information and the existing asset information.

According to another aspect of the invention, a computer-implemented method is described. The method may include crawling websites for recent asset information; tagging the websites with recent asset information and storing the tagged recent asset information in a database that includes tagged existing asset information; identifying relationships between the recent asset information and the existing asset information; identifying a technical experience for a user by matching user data with the tagged asset information using a technical experience definition; and delivering the technical experience to the user.

The method may also include receiving user data from the user.

The method may also include generating user data by analyzing user cookies.

Delivering the technical experience may include providing the user with one or more of a new product alert, editorial content, a review, a forum, a video, a download, an update, detailed product information, a link to a new product alert, a link to editorial content, a link to a review, a link to a forum, a link to a video, a link to a downloads a link to an update, and a link to detailed product information.

Delivering the technical experience may include transmitting the technical experience over a network from a server to a user computing device.

The asset information may include one or more of product information and service information.

The technical experience definition may include a rule that analyzes and assigns weights to the user data and tagged asset data based in part on the connections between the recent asset information and the existing asset information.

According to a further aspect of the invention, a machine readable medium containing computer executable instructions which cause a computer system to perform a method is described. The computer executable instructions may include instructions for crawling websites for recent asset information; instructions for tagging the websites with recent asset information and storing the tagged recent asset information in a database that includes tagged existing asset information; instructions for identifying relationships between the recent asset information and the existing asset information; instructions for identifying a technical experience for a user by matching user data with the tagged asset information using a technical experience definition; and instructions for delivering the technical experience to the user.

The machine readable medium may also include instructions for receiving user data from the user.

The machine readable medium may also include instructions for generating user data by analyzing user cookies.

The instructions for delivering the technical experience may include instructions for providing the user with one or more of a new product alert, editorial content, a review, a forum, a video, a download, an update, detailed product information, a link to a new product alert, a link to editorial content, a link to a review, a link to a forum, a link to a video, a link to a downloads a link to an update, and a link to detailed product information.

The instructions for delivering the technical experience may include instructions for transmitting the technical experience over a network from a server to a user computing device.

The asset information may include one or more of product information and service information.

The technical experience definition may include a rule that analyzes and assigns weights to the user data and tagged asset data based in part on the connections between the recent asset information and the existing asset information.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 is a block diagram of a system that provides predictive recommendations in accordance with one embodiment of the invention;

FIG. 2 is a block diagram of a technical experience engine of the predictive recommendation system in accordance with one embodiment of the invention;

FIG. 3 is a flow diagram of a method for providing predictive recommendations in accordance with one embodiment of the invention; and

FIG. 4 is a block diagram of an exemplary computer system in accordance with one embodiment of the invention.

### DETAILED DESCRIPTION

Systems and methods for building a predictive and/or user-specific asset-to-user map and building predictive recommendations using the asset-to-user map. The systems and methods use multi-dimensional asset relationships, logic layers, and user behavior data points to build a predictive environment in which new technologies that have a high degree of probability of interest to the user are displayed to the user.

In one embodiment, a “Technology Experience” or “tech experience” is used to provide the recommendation to the user. The system is configured to ascertain which tech experience (or experiences) the user is interested in and: 1) display what is necessary to “make what they have work,” (e.g., display all driver and firmware updates, news articles regarding recall info, and compatible companion products, etc.); and 2) articulate the path to the user that leads to a better experience in their personal area of interest (including editorial and news content describing what's next, updated versions of products owned, additional new product types that work with the user's existing products to create a better experience, and the like).

For example, if a user intends to enjoy digital content which may originate either in traditional format (e.g., cable TV) or in a web specific format (e.g., a streaming video), and the user intends to have the optimal experience given his or her existing products, then, simply displaying an HDMI capable video card on the same page with a TV does not go very far to elucidate the current state of affairs in media convergence. However, when the recommendation is combined with news and editorial content, applicable downloadable interface software, and the products necessary to produce the optimal experience in a multi-platform home theater (compatible with the user's currently owned products, if known), the user is presented with a rich story of the experience possible given their personal starting point. For example, the system may identify that user owns a TV capable of 1080p resolution, a Viiv enabled PC, but lack a video card capable of transferring a 1080p signal, or a receiver capable of managing such content. An exemplary tech experience for this example includes appropriate video cards and receivers for the user, as well as related content (e.g., downloadable software, news, editorial content, and the like) to assist the user in understanding the full breadth of the available products, and how the products work and interact with the user's current products, to allow the user to use the full capabilities of their TV.

The composition and relevance of the tech experience changes over time as new products and information are identified. Thus, the system is configured to proactively predict when a seemingly unrelated new product or entire new category will be of high interest to the user. The tech experience also changes when user's acquire new products. The system, therefore, provides a more useful, timely, and accurate recommendation than collaborative filters because it uses continually updated product information from a comprehensive product database, and provides product recommendations based on what a user has and new product specifications/characteristics that match what the user wants or needs.

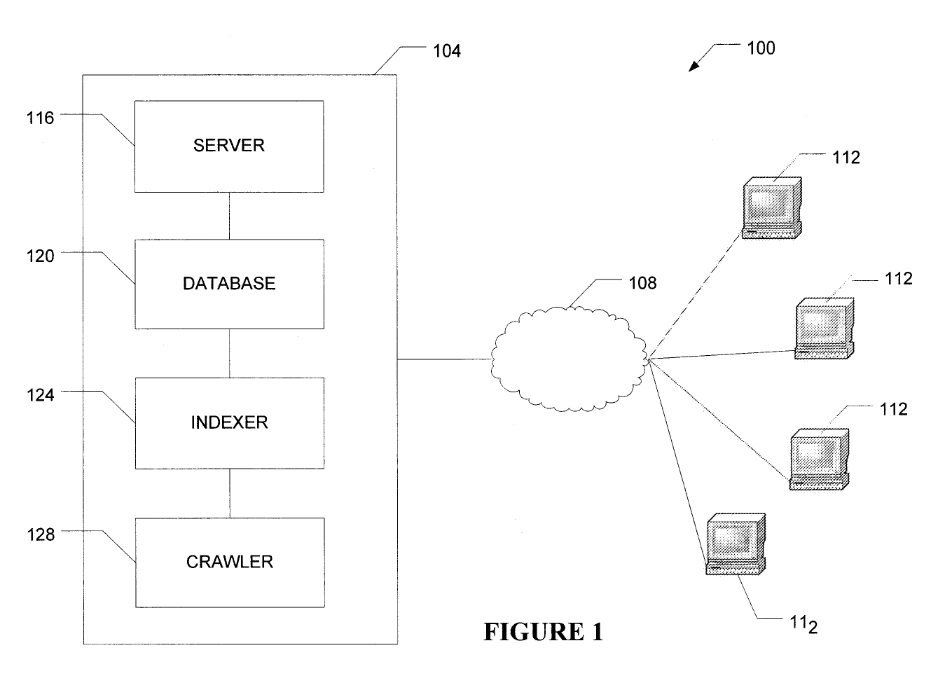

An embodiment of the invention will now be described in detail with reference to FIG. 1. FIG. 1 illustrates a system 100 for delivering the contextual based commerce experience. The system 100 includes a recommendation system 104, a network 108 and a plurality of user systems 112. The recommendation system 104 includes a server 116, a database 120, an indexer 124, and a crawler 128.

The recommendation system 104 is connected to the plurality of user systems 112 over the network 108. The server 116 is in communication with the database 120 which is in communication with the indexer 124. The indexer 124 is in communication with the crawler 128. The crawler 128 is capable of communicating with at least some of the user systems 112 over the network 108.

The server 116 is typically a computer system, and may be an HTTP (Hypertext Transfer Protocol) server. The server 116 includes at least processing logic and memory. The indexer 124 is a software program which is used to create an index, which is then stored in storage media. The index is typically a table of alphanumeric terms with a pointer identifying the location of the alphanumeric terms. An exemplary pointer is a Uniform Resource Locator (URL). The indexer 124 may build a hash table, in which a numerical value is attached to each of the terms. The database 120 is stored in a storage media, which typically includes the information which is indexed by the indexer 124. The index may be included in the same storage media as the database 120 or in a different storage media. The storage media may be volatile or non-volatile memory that includes, for example, read only memory (ROM), random access memory (RAM), magnetic disk storage media, optical storage media, flash memory devices and zip drives. The crawler 128 is a software program or software robot, which is used to build lists of the information found on web pages. The crawler 128 searches web pages on the Internet and keeps track of the information located in its search and the location of the information.

The network 108 is a local area network (LAN), wide area network (WAN), a telephone network, such as the Public Switched Telephone Network (PSTN), an intranet, the Internet, or combinations thereof.

The plurality of user systems 112 may be mainframes, minicomputers, personal computers, laptops, personal digital assistants (PDA), cell phones, and the like. The plurality of user systems 112 are characterized in that they are capable of being connected to the network 108. The plurality of user systems 112 typically include web browsers and, optionally, may host web sites.

In use, the crawler 128 crawls websites to locate information on the web pages. The crawler 128 employs software robots to build lists of the information. The crawler 128 may include one or more crawlers to search the web. The crawler 128 typically extracts the information and stores it in the database 120. The indexer 124 creates an index of the information stored in the database 120. In one embodiment, the indexer 124 tags the information and stores the tags in one or more data stores. Alternatively, if a database 120 is not used, the indexer 124 creates an index of the information and where the information is located in the Internet (typically a URL).

When a user of one of the plurality of user systems 112 is browsing a web page, browsing information is communicated to the recommendation system 104 over the network 108. For example, a signal is transmitted from one of the user systems 112, the signal having a destination address (e.g., address representing the commerce system), a request (e.g., commerce data request) and a return address (e.g., address representing user system that initiated the request). The server 116 accesses the database 120 to provide recommendation information, which is communicated to the user over the network 108. For example, another signal may be transmitted that includes a destination address corresponding to the return address of the client system, and recommendation information responsive to the request.

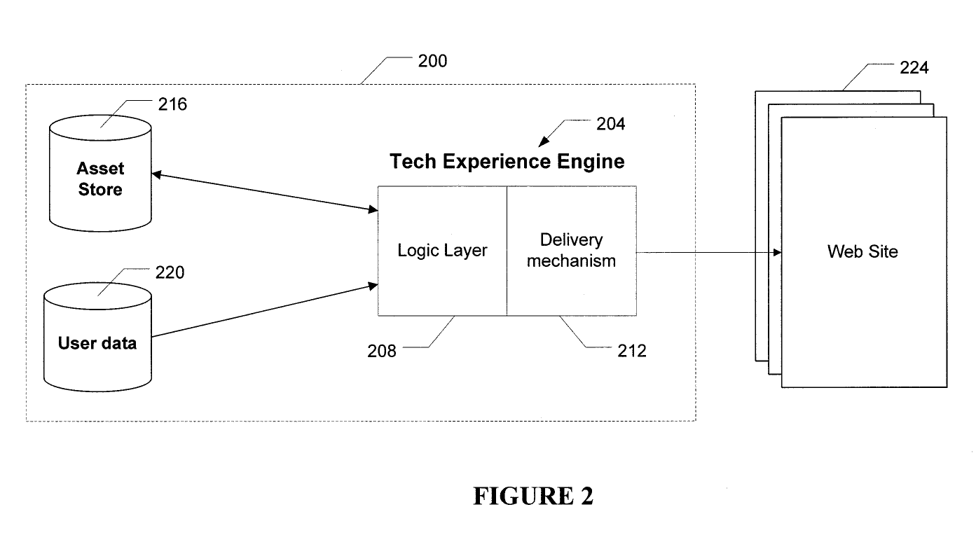

FIG. 2 illustrates a predictive recommendation system 200 according to one embodiment of the invention. The predictive recommendation system 200 may be located at the commerce system 104. In FIG. 2, the predictive recommendation system 200 includes a tech experience engine 204 that includes a logic layer 208 and a delivery mechanism 212. The logic layer 208 is in communication with an asset store 216 and a user data store 220. It will be appreciated that the logic layer 208 may also be in communication with additional data stores and/or in communication with other services (i.e., other servers or other logic layers). In addition, it will be appreciated that each data store 216, 220 may be divided into multiple data stores. A website 224 is in communication with the delivery mechanism 212.

The asset data store 216 includes tagged asset data (or metadata). In one embodiment, the tagged asset data is provided by the logic layer 208 (e.g., logic layer 208 crawls and tags websites to identify asset data, as described in further detail hereinafter). In other embodiments, the asset data is provided from merchant catalogues. It will be appreciated that the asset data may be provided from alternative sources and/or combinations of sources.

The assets may be categorized in the asset data store 216. Exemplary categories include computers, computer accessories, video cards, digital camera, televisions, etc. The asset data store 216 may include detailed information regarding asset properties and characteristics. For example, exemplary asset properties and characteristics for a digital camera may include the image resolution, image size, camera size, manufacturer, zoom level, color, display size, etc.

The asset data store 216 may also include scalarized ratings for each asset and/or asset properties. The scalarized ratings allow the logic layer 208 to identify assets that are more suitable for the user than other assets. For example, new assets may be rated higher than older products. In another example, assets with better characteristics may be rated higher. Similarly, assets with better capabilities may be rated higher.

The user data store 220 includes tagged user data that is useful for identifying a tech experience. For example, user data may be provided from registered users' profiles (e.g. assets owned by the user, products wanted, and watch list products) and/or user data may be acquired from analysis of cookies placed on the user's machine (e.g., cookies that store assets viewed and/or assets on which the user converted, i.e., purchased).

The user data may be provided indirectly. CNET Content Solutions and CNET Versiontracker, CBS Interactive owned services, are exemplary services that can be used to identify assets already owned by user. The logic layer 208 may access these services to update data in the user data store 220; alternatively, the services may be directly coupled with the asset data store 220. In another example, users can also submit information about assets they own using “Got it” pages offered by a website (i.e., website 224 or another, distinct website) associated with the recommendation system. Users can also provide data by proxy via content relationships between the provider of the product recommendation system and merchants (i.e., the merchant provides the user data to the product recommendation system).

It will be appreciated that the user data store 220 may include data about the user's interests that is obtained indirectly as well. For example, the recommendation system 200 may access a social networking application program interface (API), such as the Facebook API, to identify the user's interests. For example, if a user is a member of a guitarists group on Facebook, the user data store 220 may identify that the user is interested in guitars and/or music. Similarly, the recommendation system 200 may access a widget offered by the host website or another related website to identify additional information about a user. For example, the recommendation system 200 may identify that the user uses a widget to communicate with other musicians and store that information in the user data store 220.

As described above, the tech experience engine 204 includes the configurable logic layer 208 that is configured to link users and their products with relevant tech experiences for each user and the delivery mechanism 212 that is configured to deliver the tech experience to the user.

The tech experience engine 204 is configured to identify a user that is browsing the website 224 directly or indirectly. For example, a user may log in to a website associated with the recommendation system 200 to directly identify the user or the recommendation system 200 may identify a computer associated with the user (e.g., using the IP address of the user's computer) to indirectly identify the user.

In one embodiment, the configurable logic layer 208 includes a tagging engine that crawls websites to identify new assets. For example, certain websites (e.g., cnet.com) periodically review new assets; these websites can be crawled periodically to identify reviews of new assets and the asset properties and characteristics for that asset in the review. The data identified can be tagged and the tags can be stored in the asset data store 216. It will be appreciated that the tags may be stored with an identification of the website or without an identification of the website from which the data was tagged in the asset data store 216.

The configurable logic layer 208 may also include a rules engine that is configured to match tech experiences to the user based on tech experience definitions or rules. The tech experience definitions map keywords that the user is browsing with tech experiences using the tagged data in the asset data store 216 and the user data store 220. It will be appreciated that the tech experience definition may also match tech experiences to data only in either the asset data store 216 or the user data store 220.

For example, many users desire to watch HDTV. QAM is a spec that video cards have that enables a home entertainment system to receive unrestricted HDTV. If the logic layer 208 identifies an article that discuss QAM or identifies a product with QAM in the tagging process, the logic layer 208 can identify a connection between the article or product and QAM. Then, if a user is researching for QAM or searching for a product that includes or requires QAM, the logic layer 208 can identify the article and product with QAM as being relevant to the user and display a link to the article and/or the product.

In another example, the user data store 220 may include data that the user has installed music production software acquired via CNET Versiontracker, the user belongs to a guitarist group via the Facebook API, and the user communicates with other musicians via widgets. The logic layer 208 may then determine that based on this user data the appropriate tech experience for this user is “Musicians: Collaboration.” The delivery layer 212 may then transmit content and assets that allow for remote playing with other musicians for display on the user's computer.

The tech experience definition may also use secondary attribute driven product groupings and Live Spec (a CBS Interactive owned service) enabled dynamic product groupings to identify tech experiences for the user. Live Spec builds general category information from product summaries using the semantic information and parameters in the product summaries (e.g., Live Spec builds a category of semi-professional digital cameras based on the resolution and zoom features of cameras based on their product summaries). Additional description of dynamic product groupings (and ratings of attributes) can be found in U.S. patent application Ser. No. 11/826,559, filed Jul. 17, 2007 and entitled “System and method for generating an alternative product recommendation,” which is hereby incorporated by reference in its entirety.

The tech experience definitions may also include statistical analysis of products using the scalarized ratings of assets in the asset store 216. The strength of the relationships at the rules engine may be affected by the type of user data (e.g., whether supplied by the user through a registered user profile or identified through cookies).

The tech experience engine 204 may include a crawler that identifies keywords on the website 224 being viewed by the user. As described above, the keywords may be used to identify a tech experience definition. The rules engine uses text matching and a tagging leveraging mechanism in combination with the tech experience definitions or rules to identify tech experiences or asset recommendations for the user. The tech experience engine 204 then fetches content using the tags stored in the tech experience definitions that match the keywords on the website 224 to identify the tech experiences or recommendations for that user.

The website 224 may include a display region for the tech experience or asset recommendation. The tech experience identified by the logic layer 208 is delivered to the website 224 by the delivery mechanism 212 for display in the display region of the website 224. The tech experience delivered to the website 224 may include new product alerts, editorial content, reviews, forums, videos, downloads, updates, detailed product information, links to new product alerts, links to editorial content, links to reviews, links to forums, links to videos, links to downloads, links to updates, links to detailed product information, and combinations thereof. The tech experience can, therefore, educate users and enhance the user's experience in addition to providing new asset data, assets compatible with assets the user already owns, and the like.

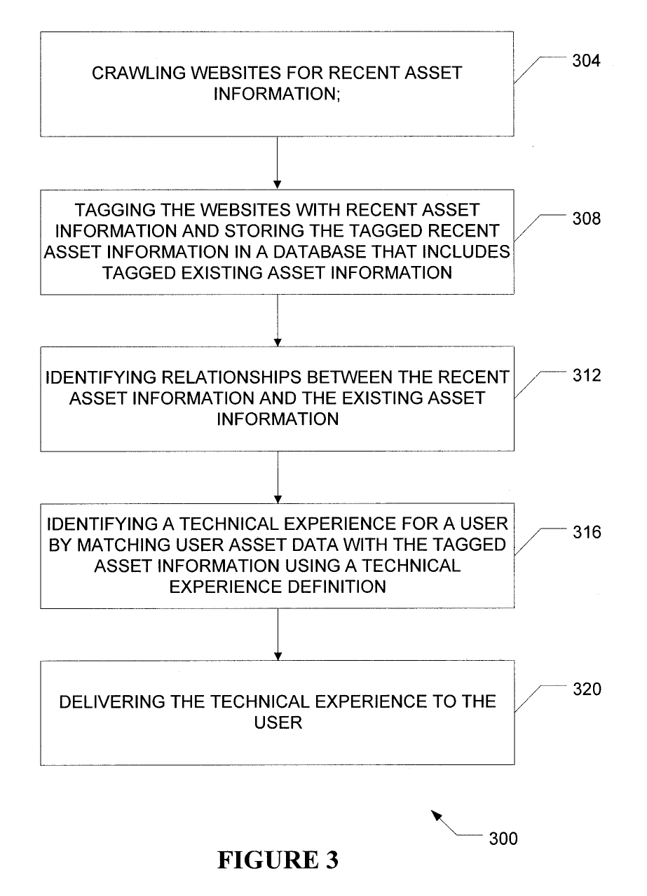

FIG. 3 illustrates a process 300 for providing predictive recommendations in accordance with one embodiment of the invention. It will be appreciated that the process 300 described below is merely exemplary and may include a fewer or greater number of steps, and that the order of at least some of the steps may vary from that described below.

The process 300 begins by crawling websites for recent asset information (block 304). The process 300 continues by tagging the websites with recent asset information and storing the tagged recent asset information in a database that includes tagged existing asset information (block 308) and identifying relationships between the recent asset information and the existing asset information (block 312). The process 300 continues by identifying a technical experience for a user by matching user asset data with the tagged asset information using a technical experience definition (block 316) and delivering the technical experience to the user (block 320).

Although the above system has been described with reference to technical product recommendations, it will be appreciated that the system may be applicable to other assets. These other assets include services, games, urban baby, cars, sports, news, food/wine, medical, patient advocacy and the like. For example, new medical studies are published all the time and new medical devices and pharmaceuticals are released frequently—can adjust rules to be specific to these other types of assets.

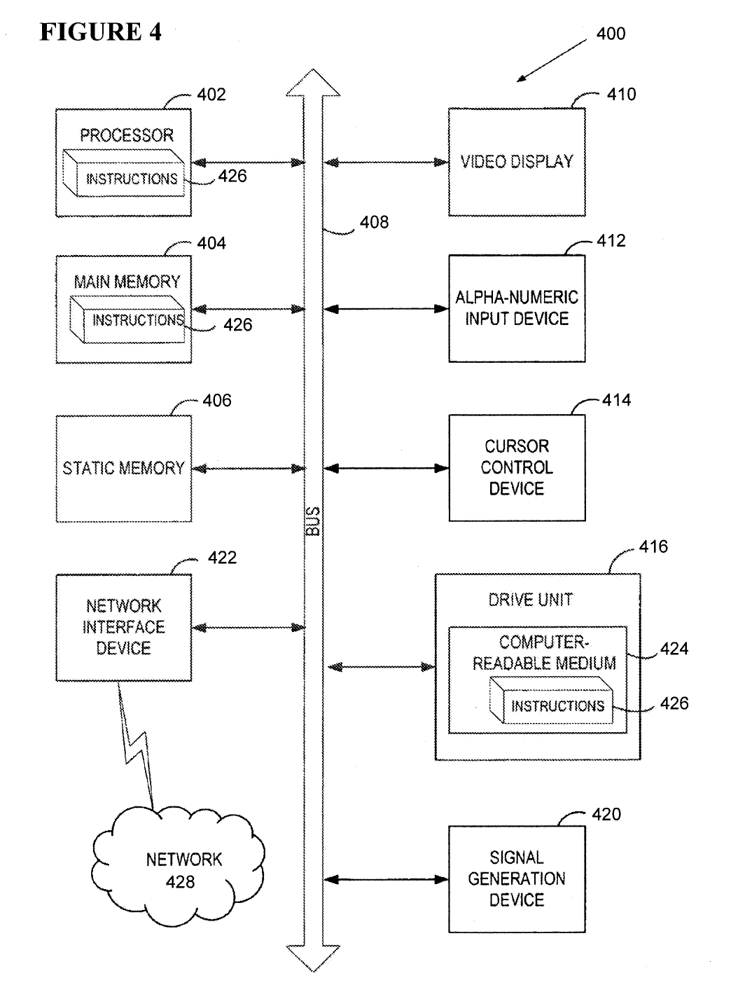

FIG. 4 shows a diagrammatic representation of machine in the exemplary form of a computer system 400 (or computing device) within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 400 includes a processor 402 (e.g., a central processing unit (CPU), a graphics processing unit (GPU) or both), a main memory 404 (e.g., read only memory (ROM), flash memory, dynamic random access memory (DRAM) such as synchronous DRAM (SDRAM) or Rambus DRAM (RDRAM), etc.) and a static memory 406 (e.g., flash memory, static random access memory (SRAM), etc.), which communicate with each other via a bus 408.

The computer system 400 may further include a video display unit 410 (e.g., a liquid crystal display (LCD) or a cathode ray tube (CRT)). The computer system 400 also includes an alphanumeric input device 412 (e.g., a keyboard), a cursor control device 414 (e.g., a mouse), a disk drive unit 416, a signal generation device 420 (e.g., a speaker) and a network interface device 422.

The disk drive unit 416 includes a machine-readable medium 424 on which is stored one or more sets of instructions (e.g., software 426) embodying any one or more of the methodologies or functions described herein. The software 426 may also reside, completely or at least partially, within the main memory 404 and/or within the processor 402 during execution thereof by the computer system 400, the main memory 404 and the processor 402 also constituting machine-readable media.

The software 426 may further be transmitted or received over a network 428 via the network interface device 422.

While the machine-readable medium 424 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

The computer system 400 is capable of transforming data which represents a physical entity, a rendered display of content or the like. Furthermore, the computer system 400 is capable of displaying the data or transmitting data for display on another computer system. For example, in the embodiments described above, the computer system 400 is capable transforming at least user browsing content on a web page and relationships between various entities into personalized recommendations. Similarly, the computer system 400 is capable of displaying the personalized recommendations on a web page and may transmit the personalized recommendations to another computer system for display on the other computer system.

It should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. The computer devices can be PCs, handsets, servers, PDAs or any other device or combination of devices which can carry out the disclosed functions in response to computer readable instructions recorded on media. The phrase “computer system”, as used herein, therefore refers to any such device or combination of such devices

Moreover, other implementations of the invention will be apparent to those skilled in the art from consideration of the specification and practice of the invention disclosed herein. Various aspects and/or components of the described embodiments may be used singly or in any combination. It is intended that the specification and examples be considered as exemplary only, with a true scope and spirit of the invention being indicated by the following claims.

What is claimed is:

1. A computer system comprising:
a user data store configured to store user data;
an asset data store configured to store tagged asset data; and
a processor coupled with the user data store and the asset data store, the processor configured to crawl websites for recent asset information, generate at least some of the tagged asset data from the recent asset information, identify connections between the recent asset information and existing asset information in the asset data store, match the user data to the tagged asset data in the asset data store using a technical experience definition and the identified connections to identify a technical experience for the user and deliver the technical experience to the user.

2. The system of claim 1, wherein the user data is provided by the user.

3. The system of claim 1, wherein the user data is determined by analyzing user cookies for user asset behavior.

4. The system of claim 1, wherein the technical experience comprises one or more of a new product alert, editorial content, a review, a forum, a video, a download, an update, detailed product information, a link to a new product alert, a link to editorial content, a link to a review, a link to a forum, a link to a video, a link to a downloads a link to an update, and a link to detailed product information.

5. The system of claim 1, wherein the processor is configured to crawl one or more of forums, blogs, reviews, articles and channel databases for new asset information.

6. The system of claim 1, wherein the tagged asset data is for one or more of a product and a service.

7. The system of claim 1, wherein the asset data comprises asset properties and asset attributes.

8. The system of claim 1, wherein the technical experience definition comprises a rule that analyzes and assigns weights to the user data and tagged asset data based in part on the connections between the recent asset information and the existing asset information.

9. A computer-implemented method comprising:
crawling websites for recent asset information;
tagging the websites with recent asset information and storing the tagged recent asset information in a database that includes tagged existing asset information;
identifying relationships between the recent asset information and the existing asset information;
identifying a technical experience for a user by matching user data with the tagged asset information using a technical experience definition; and
delivering the technical experience to the user.

10. The method of claim 9, further comprising receiving user data from the user.

11. The method of claim 9, further comprising generating user data by analyzing user cookies.

12. The method of claim 9, wherein delivering the technical experience comprises providing the user with one or more of a new product alert, editorial content, a review, a forum, a video, a download, an update, detailed product information, a link to a new product alert, a link to editorial content, a link to a review, a link to a forum, a link to a video, a link to a downloads a link to an update, and a link to detailed product information.

13. The method of claim 9, wherein delivering the technical experience comprises transmitting the technical experience over a network from a server to a user computing device.

14. The method of claim 9, wherein the asset information comprises one or more of product information and service information.

15. The method of claim 9, wherein the technical experience definition comprises a rule that analyzes and assigns weights to the user data and tagged asset data based in part on the connections between the recent asset information and the existing asset information.

16. A machine readable medium containing computer executable instructions which cause a computer system to perform a method, the computer executable instructions comprising:
instructions for crawling websites for recent asset information;
instructions for tagging the websites with recent asset information and storing the tagged recent asset information in a database that includes tagged existing asset information;
instructions for identifying relationships between the recent asset information and the existing asset information;
instructions for identifying a technical experience for a user by matching user data with the tagged asset information using a technical experience definition; and
instructions for delivering the technical experience to the user.

17. The machine readable medium of claim 16, further comprising instructions for receiving user data from the user.

18. The machine readable medium of claim 16, further comprising instructions for generating user data by analyzing user cookies.

19. The machine readable medium of claim 16, wherein instructions for delivering the technical experience comprises instructions for providing the user with one or more of a new product alert, editorial content, a review, a forum, a video, a download, an update, detailed product information, a link to a new product alert, a link to editorial content, a link to a review, a link to a forum, a link to a video, a link to a downloads a link to an update, and a link to detailed product information.

20. The machine readable medium of claim 16, wherein instructions for delivering the technical experience comprises instructions for transmitting the technical experience over a network from a server to a user computing device.

21. The machine readable medium of claim 16, wherein the asset information comprises one or more of product information and service information.

22. The machine readable medium of claim 16, wherein the technical experience definition comprises a rule that analyzes and assigns weights to the user data and tagged asset data based in part on the connections between the recent asset information and the existing asset information.
